(19) United States
(12) Patent Application Publication
(10) Pub. No.: US 2026/0267011 A1
(43) Pub. Date: Sep. 10, 2026

(54) SYSTEMS AND METHODS OF REAL-TIME KINEMATIC BASE STATION INTEGRATION WITH ROAD INFRASTRUCTURE

(71) Applicant: Torc Robotics, Inc., Blacksburg, VA (US)

(72) Inventors: Maximilian Yassine Beyen, Leutenbach (DE); Maximilian Koeper, Ostfildern (DE); Simon Baeuerle, Kassel (DE); Marat Kopytjuk, Heilbronn (DE); Margarita Kunjavskaja, Gerlingen (DE)

(21) Appl. No.: 19/073,619

(22) Filed: Mar. 7, 2025

(51) Int. Cl. G01S 19/43; G01S 19/13

(52) U.S. Cl. CPC G01S 19/43; G01S 19/13

(57) ABSTRACT

A real-time kinematic (RTK) expansion system for expanding coverage of a network of RTK base stations includes one or more RTK base stations. Each RTK base station of the one or more RTK base stations is configured to provide real-time positioning corrections to a vehicle. Each RTK base station includes a Global Navigation Satellite System (GNSS) antenna, GNSS receiver, processor, and memory configured generate real-time corrections that compensate for errors. Additionally, the RTK base station includes a communication interface configured to transmit real-time corrections to the moving navigation system, thereby enabling the moving navigation system to achieve high-precision positioning. The one or more RTK base stations are installed on one or more existing road infrastructure elements, locations of the one or more existing road infrastructure elements selected to be outside a coverage of a current network of RTK base stations.

### TECHNICAL FIELD

The field of the disclosure relates generally to global navigation networks and, more specifically, systems and methods of integrating real-time kinematic base stations with road infrastructure.

### BACKGROUND OF THE INVENTION

Autonomous vehicles rely on precise navigation systems to ensure safe and accurate operation. One key technology used for this purpose is real-rime kinematic (RTK) positioning, which offers high-accuracy GPS measurements by correcting the standard GPS signal with data from a nearby base station. RTK networks, composed of multiple base stations and rovers, have been widely used in various fields, such as agriculture, surveying, and construction, to provide centimeter-level accuracy for positioning. However, the scalability of existing RTK networks is limited, particularly in expansive or rapidly changing environments where more base stations are required to maintain high accuracy and reliability. As autonomous vehicles become more widespread, the demand for larger RTK networks capable of supporting these vehicles' navigation needs increases. Current solutions face challenges in efficiently expanding the coverage area, improving network reliability, and managing data processing requirements. Accordingly, there is a need for improved systems and methods to increase the size and scalability of RTK networks to enhance the navigational capabilities of autonomous vehicles over a larger area.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed real-time kinematic (RTK) expansion system for expanding coverage of a network of RTK base stations includes one or more RTK base stations. Each RTK base station of the one or more RTK base stations is configured to provide real-time positioning corrections to a vehicle. Each RTK base station includes a Global Navigation Satellite System (GNSS) antenna configured to receive GNSS signals from one or more satellite constellations. The RTK base station also includes a GNSS receiver coupled to the GNSS antenna, configured to decode the GNSS signals received from the GNSS antenna and generate real-time corrections that compensate for errors. The corrections compensate for errors in satellite signal reception. The RTK base station further includes a memory configured to store the decoded the GNSS signals and a processor configured to process decoded the GNSS signals. Additionally, the RTK base station includes a communication interface configured to transmit real-time corrections to the moving navigation system, thereby enabling the moving navigation system to achieve high-precision positioning. The one or more RTK base stations are installed on one or more existing road infrastructure elements, locations of the one or more existing road infrastructure elements selected to be outside a coverage of a current network of RTK base stations.

In another aspect, the disclosed method of expanding coverage of a network of real-time kinematic (RTK) base stations, includes expanding coverage of a network of RTK base stations by providing one or more RTK base stations, each of the one or more RTK base stations configured to provide real-time positioning corrections to a vehicle. The method also includes determining coverage of a current network of RTK base stations. The method further includes selecting one or more existing road infrastructure elements located outside the coverage of the current network of RTK base stations. Additionally, the method includes adding the one or more RTK base stations to the network of RTK base stations by installing the one or more RTK base stations on one or more existing road infrastructure elements.

In yet another aspect, the disclosed autonomy computing system of an autonomous vehicle includes at least one processor in communication with at least one memory device. The at least one processor further programmed to communicate with an expanded network of RTK base stations. The expanded network of RTK base stations includes one or more RTK base stations. Each of the one or more RTK base stations configured to provide real-time positioning corrections to a vehicle. The RTK base station includes a Global Navigation Satellite System (GNSS) antenna configured to receive GNSS signals from one or more satellite constellations. The RTK base station also includes a GNSS receiver coupled to the GNSS antenna, configured to decode the GNSS signals received from the GNSS antenna and generate real-time corrections that compensate for errors. The corrections compensate for errors in satellite signal reception. The RTK base station further includes a memory configured to store the decoded the GNSS signals and a processor configured to process decoded the GNSS signals. Additionally, the RTK base station includes a communication interface configured to transmit real-time corrections to the moving navigation system, thereby enabling the moving navigation system to achieve high-precision positioning. The one or more RTK base stations are installed on one or more existing road infrastructure elements, locations of the one or more existing road infrastructure elements selected to be outside a coverage of a current network of RTK base stations.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a schematic diagram of an example navigation network with a real-time kinematic (RTK) base station;

FIG. 4A is a block diagram of an example RTK base station;

FIG. 4B is a schematic diagram of an example road infrastructure system with integration RTK base station;

FIG. 5 is a flow chat of an example method of expanding coverage of a network of RTK base stations; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of real-time kinematic (RTK) base station integration with road infrastructure are provided. The navigation network and associated RTK-based positioning system offer numerous advantages for high-precision, real-time applications. One of the benefits is the ability to provide centimeter-level positioning accuracy, which is critical for dynamic environments such as autonomous vehicle navigation, surveying, and precision agriculture. By leveraging real-time corrections from RTK base stations, the system significantly reduces errors caused by satellite signal interference, atmospheric delays, and multipath effects, ensuring highly accurate and reliable positioning data.

The integration of RTK base stations with existing road infrastructure further enhances the system's efficiency and scalability. This integration reduces the need for additional, dedicated infrastructure, resulting in cost savings and easier deployment. Additionally, utilizing existing power supplies and communication networks from road infrastructure allows for seamless, low-latency transmission of real-time corrections to mobile inertial navigation system units. This is particularly advantageous in remote environments, where multiple base stations may provide continuous coverage over vast areas, ensuring uninterrupted Global Navigation Satellite System (GNSS) corrections for moving vehicles or devices.

The use of high-frequency updates and carrier-phase measurements in the disclosed system provides real-time accuracy, even in complex environments with challenging GNSS reception, such as urban canyons, remote areas, or areas with dense foliage. The RTK base stations, equipped with advanced GNSS antennas and receivers, deliver robust, reliable signal reception, ensuring that the positioning system remains effective in diverse conditions. Furthermore, the ability to deploy multiple base stations over large areas ensures that the system may scale as needed to meet the requirements of large-scale operations.

Accordingly, the integration of RTK base stations with existing road infrastructure provides a comprehensive, efficient, and scalable solution for high-precision positioning in real-time, offering increased reliability, accuracy, and flexibility for a variety of critical applications.

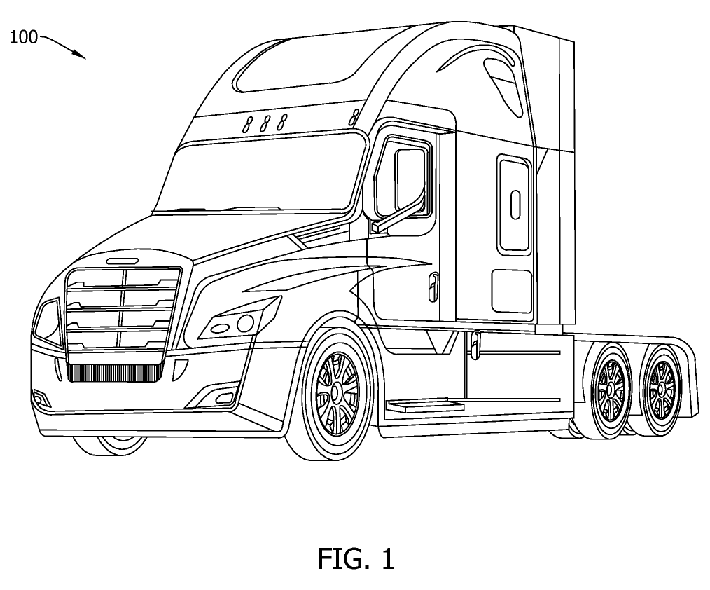

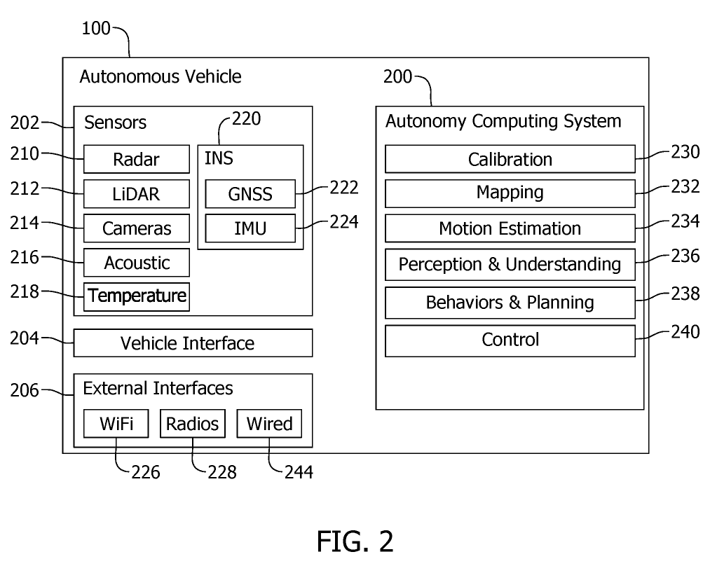

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird’s eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

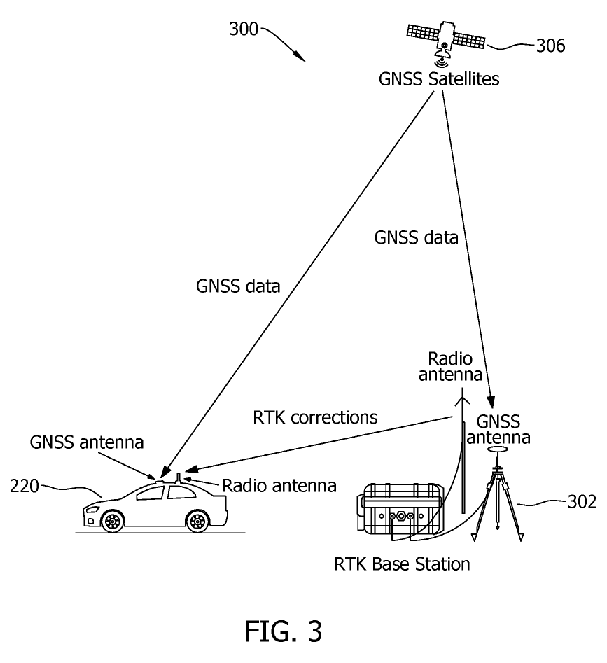

FIG. 3 is a schematic diagram of an example navigation network 300 including a RTK base station 302. RTK is a GNSS technique for providing enhanced positioning accuracy in real-time by correcting data with a fixed RTK base station 302. Navigation network 300 includes one or more RTK base stations 302, one or more INS 220, and one or more GNSS satellites 306. RTK base station 302 is a stationary receiver situated at a known, precisely surveyed location, and it communicates with INS 220 (i.e., a moving GNSS receiver) via a data link for the purpose of transmitting real-time error corrections. These corrections are vital in removing inaccuracies arising from satellite orbit errors, atmospheric effects, and multipath interference, thus enabling the rover to achieve centimeter-level accuracy.

In the example embodiment, navigation network 300 achieves high accuracy by measuring the carrier phase of the GNSS signals, which provides a more precise signal measurement than the pseudorange method (which typically leads to positioning errors in the range of several meters). Navigation network 300 measures the difference in phase between the received signal and a reference signal from a fixed known point, improving accuracy by detecting small changes in the signal. The corrected position data from RTK base station 302 enables INS 220 to apply real-time adjustments to its location, which are then used to calculate its position with a high degree of precision. This process occurs at rapid intervals (e.g., every second), enabling real-time applications that require dynamic and accurate positioning, such as autonomous vehicle navigation, aerial drones, and precision agriculture equipment.

In the example embodiment, INS 220 is a mobile GNSS receiver that receives the same satellite signals as RTK base station 302 but without knowledge of its precise location. As a result, INS 220 calculates its position with reduced accuracy, often resulting in errors of several meters. However, when INS 220 receives correction data from RTK base station 302, INS 220 applies these real-time corrections to refine its position. The correction data transmitted from RTK base station 302 typically consists of position adjustments that compensate for common satellite signal errors, such as atmospheric delays (e.g., ionospheric and tropospheric delays), satellite clock inaccuracies, and multipath effects (i.e., when signals bounce off buildings or other reflective surfaces). These errors, if left uncorrected, may lead to significant inaccuracies, particularly in high-precision applications where centimeter-level accuracy is required.

In the example embodiment, navigation network 300 leverage carrier-phase measurements, which are substantially more precise than standard pseudorange measurements, enabling centimeter-level accuracy by comparing the phase of the electromagnetic waves of the satellite signals. This method, however, requires high-quality signal reception and continuous communication with RTK base station 302. As such, RTK is especially well-suited for applications such as surveying, autonomous vehicles, and other industrial applications that demand high-precision positioning. High-precision positioning refers to the ability to determine the position of an object with a high degree of accuracy, often yielding coordinate outputs within a few centimeters or millimeters of the object's true position. For example, autonomous vehicles use RTK corrections to accurately navigate complex environments, such as city streets or construction sites, where high-definition mapping and real-time positioning are crucial for safe operation.

In the example embodiment, navigation network 300 also utilize high-frequency updates, often occurring once per second or more frequently, to provide real-time positioning. Navigation network 300 may be employed in applications where dynamic mapping, navigation, and automation are required. For example, for RTK base station 302 and INS 220 to remain synchronized, it is crucial to minimize any communication latency (delays in transmitting correction data) to maintain real-time accuracy in INS 220 position. Latency can be caused by network congestion, poor signal quality, or other environmental factors, and can result in a degradation of system performance. As a result, efficient data transmission protocols and low-latency communication links may be implemented to ensure real-time updates.

In the example embodiment, the effectiveness of navigation network 300 may be influenced by several factors, including the quality of the GNSS signals, environmental conditions (e.g., signal obstruction by buildings or trees), proximity of INS 220 to base station 302, and the stability of the communication network. GNSS signals are susceptible to multipath effects, where signals reflect off buildings, vehicles, or other structures before reaching the receiver. These reflected signals can cause positioning errors if not accounted for properly. Multipath effects are mitigated by using high-precision antennas and advanced signal processing algorithms that filter out or compensate for such errors. Environmental conditions such as heavy rainfall, snow, or dense foliage can also reduce the quality of the GNSS signals, requiring additional signal processing or auxiliary systems, such as LiDAR or radar, to ensure continued accuracy in harsh conditions.

Although RTK base station 302 may be located several kilometers from INS 220, longer distances may result in reduced accuracy due to the delay in transmitting correction data. However, navigation network 300 may mitigate this by deploying a network of a plurality of RTK base stations 302 that deliver correction data over a broader infrastructure, enabling reliable corrections over greater distances. This setup is especially useful in applications such as large-scale land surveys or autonomous vehicle fleets, where continuous coverage across a wide area is necessary. In these systems, multiple RTK base station 302 are strategically placed to ensure that INS 220 always receives correction data from the nearest base station, minimizing the effects of distance-based errors.

In the example embodiment, the combination of differential GNSS techniques and real-time communication makes RTK one of the most accurate and reliable solutions for high-precision positioning in real-time. Furthermore, navigation network 300 may be integrated with other sensors, such as inertial measurement units (IMUs) and LiDAR, to provide continuous, uninterrupted tracking and positioning even when GNSS signals are weak or unavailable.

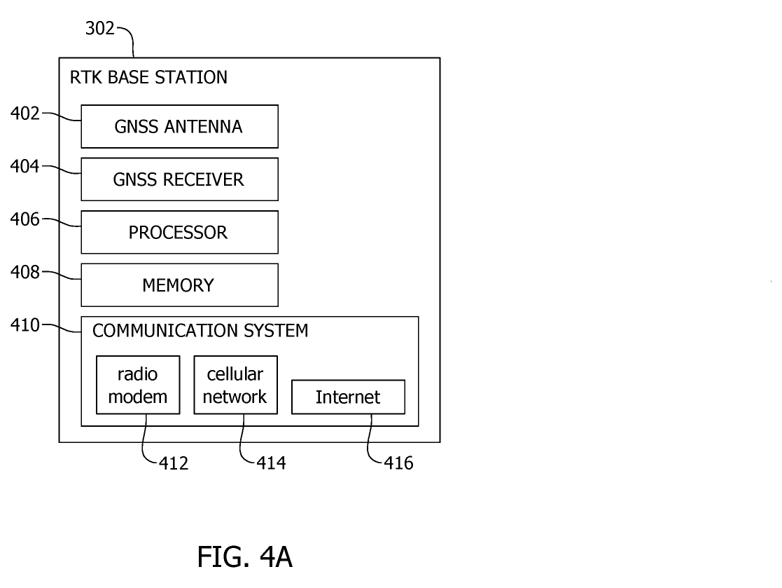

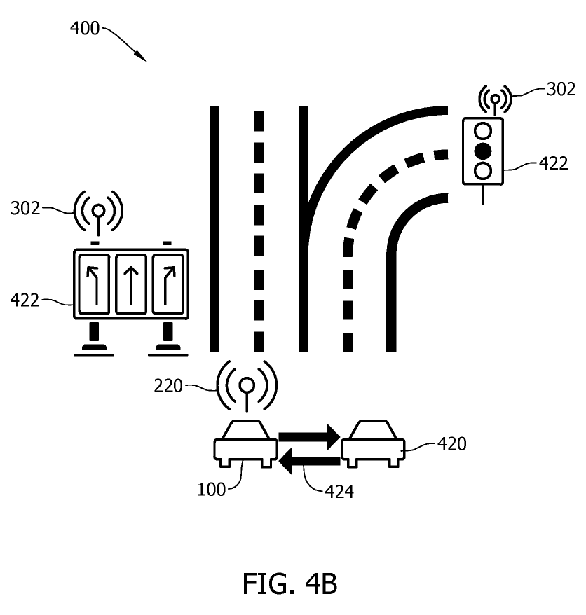

FIG. 4A is a block diagram illustrating the components of an example RTK base station 302. RTK base station 302 integrates several critical components, including a GNSS antenna 402, GNSS receiver 404, processor 406, memory 408, and external interface 410, to provide high-precision, real-time corrections to INS 220 or another navigation system.

In the example embodiment, GNSS antenna 402 receives signals from multiple satellite constellations, such as GPS, GLONASS, Galileo, and Beidou, ensuring robust reception of positioning signals. GNSS antenna 402 is designed to receive both carrier phase and pseudorange measurements, which are essential for RTK-based corrections. The quality of the antenna plays a crucial role in signal accuracy, and high-precision antennas used in RTK applications often incorporate advanced filtering techniques to minimize interference from non-GNSS signals and reduce the impact of multipath errors (i.e., when signals reflect off nearby structures). GNSS antenna 402 may be positioned in an elevated location (e.g., on a pole or tripod) to maximize its line of sight to the sky and minimize signal obstructions.

In the example embodiment, GNSS receiver 404 decodes the signals received from GNSS antenna 402. GNSS receiver 404 tracks both pseudorange measurements (which estimate the distance to each satellite based on signal travel time) and carrier-phase measurements (which provide more precise measurements of signal phase). By analyzing this data, GNSS receiver 404 calculates the base station's position and the associated errors (e.g., atmospheric delays, satellite clock inaccuracies, and multipath effects). GNSS receiver 404 may track signals from multiple satellite constellations, increasing reliability and redundancy for improved accuracy.

In the example embodiment, processor 406 is responsible for processing the raw data received from GNSS receiver 404. Processor 406 analyzes both the carrier-phase and pseudorange measurements to generate real-time corrections that compensate for errors such as ionospheric and tropospheric delays, satellite orbital inaccuracies, and multipath effects. These corrections are essential for achieving centimeter-level positioning accuracy. Processor 406 also handles communication tasks, ensuring the correction data is prepared for transmission to INS 220 or another navigation system. Additionally, processor 406 may run error correction algorithms in real time, adjusting for dynamic environmental conditions and signal disruptions as needed.

In the example embodiment, memory 408 stores the raw GNSS data received from GNSS receiver 404, as well as the processed correction data. Memory 408 may also store logs of important events, such as system health checks, satellite tracking information, and diagnostic data. This storage allows for real-time access to correction data and the ability to troubleshoot and monitor the system's performance over time. Memory 408 may be capable of storing high-frequency data and long-term GNSS logs for post-processing, which can be useful for applications such as land surveying or mapping.

In the example embodiment, external interface 410 facilitates communication between RTK base station 302 and other systems, such as INS 220. External interface 410 supports various communication methods, including radio modems 412 (e.g., UHF/VHF frequencies), cellular networks 414 (e.g., LTE or 5G), and internet connections 416 (e.g., IP-based networks). These communication channels enable RTK base station 302 to transmit real-time correction data to INS 220 or other navigation systems, ensuring the receiver maintains accurate positioning information. External interface 410 also supports data aggregation for networked RTK applications, where multiple base stations share data to provide corrections across larger areas.

In some embodiments, the power supply to RTK base station 302 may be integrated with existing infrastructure (e.g., a traffic light or streetlight), or the power supply may be provided by a stand-alone system such as solar panels or batteries. The power supply is stable and robust to ensure RTK base station operates continuously, 24/7. The power system is capable of supporting long-term operation in remote or urban environments, where access to external power sources may be limited.

In some embodiments, RTK base station 302 may be connected to more than one power supply. For example, RTK base station 302 may be connected to both a power supply integrated with existing infrastructure and a stand-alone power supply. In further example embodiments, RTK base station 302 may be connected to a renewable power supply, for example, solar energy, wind energy, hydroelectric energy, biomass energy, hydrogen and fuel cells, geothermal power, tidal energy, or other.

In the example embodiment, an enclosure system is provided to protect RTK base station 302 components from harsh environmental conditions, such as rain, snow, dust, extreme temperatures, and physical impacts. The enclosure ensures that the sensitive electronics, particularly GNSS antenna 402 and GNSS receiver 404, are shielded from these elements, reducing the risk of signal degradation and damage. The enclosure may be integrated into an existing piece of road infrastructure, such as a traffic light control box, or the enclosure may be a stand-alone, weather-resistant container designed to withstand outdoor conditions. Additionally, in some embodiments, GNSS antenna 402 may be mounted on a pole or tripod to elevate it and ensure an unobstructed view of the sky, which is essential for optimal signal reception.

FIG. 4B is a schematic diagram of an example RTK road infrastructure system 400 with integration of RTK base station 302. RTK road infrastructure system 400 includes at least one navigation network 300 where one or more RTK base stations 302 are integrated with existing road infrastructure 422. In some embodiments, RTK base stations 302 may be integrated with various elements of road infrastructure 422, including but not limited to road signs, traffic lights, bridges, tunnels, railroad crossings, barricades, traffic cameras, bus stops, or other suitable infrastructure elements. The integration of RTK base stations 302 with road infrastructure 422 provides an efficient and effective way to deploy a network of base stations that deliver real-time GNSS corrections to moving receivers, such as INS 220, for high-precision positioning applications.

In the example embodiment, RTK base stations 302 are integrated with existing road infrastructure 422 to reduce the cost and complexity of deploying additional infrastructure dedicated solely to RTK corrections. For example, RTK base stations 302 may be housed within or attached to a traffic light pole, streetlight, road sign, or similar structure, utilizing the infrastructure's power supply and network connectivity. This strategic integration ensures that RTK base stations 302 are deployed efficiently without the need for standalone installations in remote or difficult-to-reach locations. By utilizing existing infrastructure, the system also minimizes the need for additional physical space and reduces the installation time.

In some embodiments, the power supply for RTK base station 302 is provided by the existing road infrastructure 422. For example, power may be sourced from the AC or DC electrical systems integrated into traffic lights, streetlights, or other road infrastructure elements. Additionally or alternatively, RTK base stations 302 may be equipped with independent power systems, such as a renewable power supply like solar panels or batteries, to ensure continuous operation in locations where access to external power is limited, interrupted, or unreliable. These power systems provides stable and uninterrupted power to RTK base stations 302 to support 24/7 operation, ensuring that real-time GNSS corrections are available whenever needed.

In the example embodiment, RTK base stations 302 may also include communication systems that integrate with existing road infrastructure 422. For example, communication systems within RTK base stations 302 may use cellular networks, radio modems, or Wi-Fi connections that are already available within road infrastructure elements such as traffic cameras or connected traffic management systems. By leveraging existing communication networks, RTK base stations 302 may transmit correction data to moving receivers (INS 220) or other navigation systems with low-latency, real-time performance, ensuring continuous, precise positioning information.

In some embodiments, RTK base station 302 is housed within an enclosure system designed to protect the base station's electronics from environmental factors such as weather, dust, temperature extremes, and physical impact. The enclosure system may be integrated into the housing of existing road infrastructure 422, such as a traffic light control box or streetlight enclosure, to provide both physical protection and seamless integration. Alternatively, the enclosure system may be a standalone, ruggedized housing designed specifically for RTK base station 302, providing additional durability for deployment in harsh environments. The enclosure ensures that sensitive components such as GNSS antenna 402 and GNSS receiver 404 are shielded from damage while maintaining optimal performance.

In further embodiments, GNSS antenna 402 of RTK base station 302 may be mounted on a pole or tripod, elevating GNSS antenna 402 to improve its line of sight to the sky and maximize signal reception from GNSS satellites. This elevated placement helps avoid signal obstructions caused by surrounding structures, such as buildings, trees, or other objects, which could interfere with the reception of satellite signals. The integration of the antenna with road infrastructure 422, when properly elevated and installed, ensures that RTK base station 302 may deliver accurate corrections to moving receivers (e.g., INS 220) in real time.

In some example embodiment, the system 400 may also leverage vehicle-to-vehicle (V2V) communication 424 to share the corrected position data among vehicles in the vicinity. By using V2V communication 424, a vehicle 100 equipped with INS 220 may broadcast its corrected position data to neighboring vehicles 420, enabling neighboring vehicles 420 to adjust their own positions based on the more accurate data. This collaborative exchange of positioning information is especially beneficial in environments where multiple vehicles are operating in close proximity, such as on busy city streets, highways, or in platooning scenarios.

In some example embodiment, V2V communication 424 facilitates the sharing of real-time corrections without the need for each vehicle to independently receive corrections from the RTK base stations 302. For instance, in a highway scenario, a vehicle 100 receiving high-accuracy GNSS corrections from an RTK base station 302 may communicate its precise position and velocity to other vehicles 420 in the convoy or surrounding area. These neighboring vehicles 420, in turn, may use the shared data to enhance their own positioning accuracy, reducing the overall positioning error across the fleet of vehicles. Such collaboration is particularly advantageous in autonomous vehicle fleets, where the safety and efficiency of operations depend on maintaining accurate and synchronized positioning.

In some example embodiment, V2V communication 424 may help to improve the robustness of the navigation system in challenging environments. In cases where the signal from an RTK base station 302 is weak or temporarily unavailable (due to environmental factors like tall buildings or tunnels), vehicles 100 may rely on position information shared by other vehicles 420 to maintain accurate navigation. By pooling data from multiple sources, V2V communication 424 increases the system's resilience to signal degradation and enhances overall positioning reliability.

In some example embodiment, the combination of RTK base stations 302, V2V communication 424, and real-time GNSS corrections enables a dynamic and cooperative positioning system that may support a wide range of applications, from autonomous vehicle navigation to coordinated traffic management. The integration of V2V communication 424 further optimizes the RTK road infrastructure system 400 by enabling vehicles to benefit from each other’s corrected positions, reducing the need for additional infrastructure and making the entire system more efficient and cost-effective.

The integration of RTK base stations 302 with road infrastructure 422 allows for the creation of a networked RTK system, where multiple RTK base stations 302 are deployed along roadways or other infrastructure elements. These base stations are strategically placed to ensure continuous, high-accuracy GNSS corrections over a broad area, enabling applications such as autonomous vehicle navigation, precision farming, surveying, and other high-precision positioning needs. The RTK road infrastructure system 400 provides an infrastructure-based solution for large-scale, real-time positioning applications by ensuring that there is no gap in correction data as vehicles or equipment move across large distances.

The RTK road infrastructure system 400 is particularly well-suited for large-scale deployments, where multiple RTK base stations 302 may be distributed along major highways, city streets, or other critical routes. This ensures a seamless and continuous flow of accurate GNSS correction data, minimizing positioning errors that may arise due to signal interruptions, obstructions, or environmental factors. The integration with road infrastructure 422 makes the system easy to maintain and expand as infrastructure evolves and the need for high-precision positioning increases.

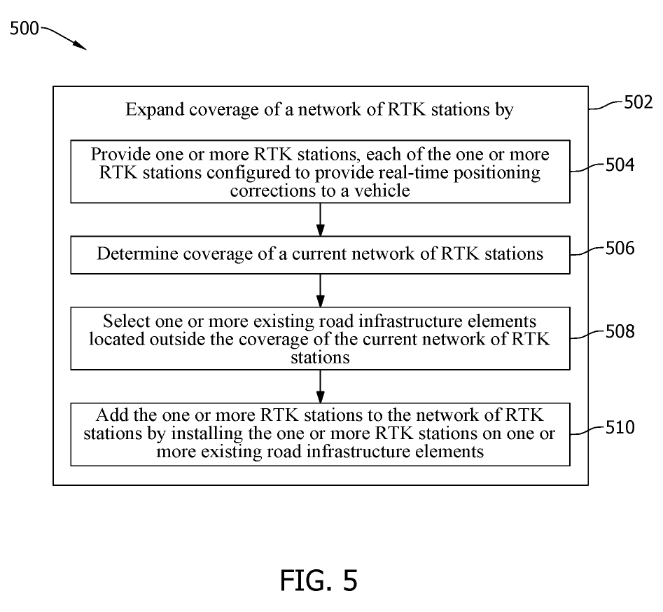

FIG. 5 is a flow chat of an example method 500 of expanding coverage of a network of RTK base stations. The example method 500 includes expanding 422 coverage of a network of RTK base stations. Expanding 422 includes providing 420 one or more RTK base stations. Each of the one or more RTK base stations configured to provide real-time positioning corrections to a vehicle. Expanding 422 also includes determining 420 coverage of a current network of RTK base stations. Expanding 422 further includes selecting 506 one or more existing road infrastructure elements located outside the coverage of the current network of RTK base stations and adding 510 the one or more RTK base stations to the network of RTK base stations by installing the one or more RTK base stations on one or more existing road infrastructure elements.

In some example embodiments, method 500 may also include expanding the coverage to achieve continuous coverage in a geographical area by the current network of RTK base stations and the one or more newly added RTK base stations. Continuous coverage refers to the uninterrupted provision of real-time GNSS corrections across the entire coverage area, ensuring that there are no gaps or periods of non-coverage as vehicles or equipment move within the area. Continuous coverage may be achieved by strategically placing additional RTK base stations to clear gaps in coverage, maintain a seamless transition of correction data between RTK base stations, and avoid signal disruptions or inaccuracies caused by gaps in coverage. Continuous coverage may involve selection of RTK base station locations based on their operational ranges, ensuring that each RTK base station's signal range overlaps with that of neighboring RTK base stations. As a result, the vehicles or systems within the coverage area experience consistent and reliable GNSS corrections, regardless of movement or the environmental conditions.

In some example embodiments, method 500 may also include determining the ranges of the one or more RTK base stations and selecting the one or more existing road infrastructure elements at locations such that the ranges of the one or more RTK base stations are optimized to increase the coverage of the current network of RTK base stations. The range of each RTK base station refers to the area within which it can effectively transmit GNSS correction data to vehicles or equipment. To ensure seamless coverage, the method may involve analyzing the operational range of each RTK base station based on factors such as signal strength, topography, environmental conditions, and potential obstacles (e.g., buildings or natural features). By determining the effective range of RTK base stations, strategic locations along existing road infrastructure elements may be identify, such as traffic lights, streetlights, or road signs, where the RTK base stations may be placed to maximize their coverage. Proper placement of RTK base stations ensures that the coverage area is extended and that multiple RTK base stations' ranges intersect, providing continuous and uninterrupted correction data.

In some example embodiments, method 500 may also include powering the one or more RTK base station using a power supply derived from a power supply to the one or more existing road infrastructure elements.

In some example embodiments, method 500 may also include powering the one or more RTK base station using a power supply separate from a power supply to the one or more existing road infrastructure elements.

In some example embodiments, method 500 may also include powering the one or more RTK base station using a renewable power supply.

In some example embodiments, method 500 may also include expanding the coverage using vehicle-to-vehicle (V2V) communication from vehicles within the coverage area. V2V communication allows vehicles to share real-time GNSS correction data with each other, enhancing the overall coverage and positioning accuracy of the network. When an RTK base station may have limited coverage or its signal is temporarily degraded due to environmental factors (e.g., tall buildings or tunnels), vehicles equipped with GNSS receivers may use V2V communication to exchange positioning data. This collaborative sharing enables vehicles to maintain accurate navigation and positioning even in areas where direct RTK corrections are unavailable. The vehicles may broadcast their corrected positions, along with their velocity and other relevant data, to nearby vehicles, which in turn can adjust their own positioning. By leveraging the data from multiple vehicles in the vicinity, the overall reliability and accuracy of positioning across the network are improved, effectively expanding the coverage area. This expansion of coverage through V2V communication is especially beneficial in high-density areas or dynamic environments where vehicles are constantly moving and may experience signal disruptions. Moreover, V2V communication may enhance the resilience of the entire system, as vehicles may rely on data from others to mitigate potential gaps in coverage or periods of signal degradation, ensuring continuous and robust positioning capabilities.

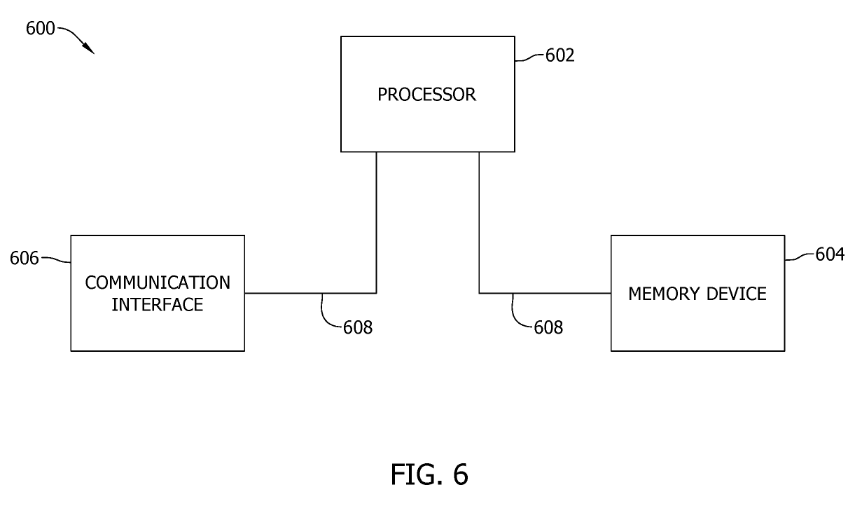

FIG. 6 is a block diagram of an example computing device 600. Computing device 600 includes a processor 602 and a memory device 604. Processor 602 is coupled to memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 604 includes one or more devices that enable information, such as executable instructions or other data (e.g., sensor data), to be stored and retrieved. Moreover, memory device 604 includes one or more computer readable media, such as, without limitation, dynamic random-access memory (DRAM), static random access memory (SRAM), a solid state disk, or a hard disk. In the example embodiment, memory device 604 stores, without limitation, application source code, application object code, configuration data, additional input events, application states, assertion statements, validation results, or any other type of data. Computing device 600, in the example embodiment, may also include a communication interface 606 that is coupled to processor 602 via system bus 608. Moreover, the communication interface 606 is communicatively coupled to data acquisition devices.

In the example embodiment, processor 602 may be programmed by encoding an operation using one or more executable instructions and providing the executable instructions in memory device 604. In the example embodiment, processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) cost effective navigational network expansion (b) reduced footprint of navigational network expansion or (c) increased accessibility of navigational network base stations.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A real-time kinematic (RTK) expansion system for expanding coverage of a network of RTK base stations, the RTK expansion system comprising:
one or more RTK base stations, each RTK base station of the one or more RTK base stations configured to provide real-time positioning corrections to a vehicle, the each RTK base station comprising:
a Global Navigation Satellite System (GNSS) antenna configured to receive GNSS signals from one or more satellite constellations;
a GNSS receiver coupled to the GNSS antenna, configured to decode the GNSS signals received from the GNSS antenna and generate real-time corrections that compensate for errors, wherein the corrections compensate for errors in satellite signal reception;
a memory configured to store the decoded GNSS signals;
a processor configured to process the decoded GNSS signals; and
a communication interface configured to transmit real-time corrections to a moving navigation system, thereby enabling the moving navigation system to achieve high-precision positioning,
wherein the one or more RTK base stations are installed on one or more existing road infrastructure elements at locations selected to be outside a coverage area of a current network of RTK base stations.

2. The RTK expansion system of claim 1, further comprising a power supply configured to provide power to the RTK base station, wherein the power supply is derived from the road infrastructure element’s existing electrical system.

3. The RTK expansion system of claim 1, further comprising a power supply configured to provide power to the RTK base station, wherein the power supply is separate from a power supply to the road infrastructure element.

4. The RTK expansion system of claim 1, further comprising a power supply configured to provide power to the RTK base station, wherein the power supply is a renewable power supply.

5. The RTK expansion system of claim 1, further comprising a vehicle-to-vehicle (V2V) communication system that enables vehicles within a coverage area to communicate, thereby enhancing the real-time positioning corrections provided by the RTK base stations.

6. The RTK expansion system of claim 1, wherein the road infrastructure element is selected from a group including traffic lights, streetlights, road signs, bridges, tunnels, railroad crossings, or bus stops.

7. The RTK expansion system of claim 1, wherein the RTK base station is housed in a weatherproof enclosure to protect the components from environmental exposure, such as rain, snow, or extreme temperatures.

8. The RTK expansion system of claim 1, wherein the GNSS antenna comprises a multi-frequency antenna configured to receive signals from at least two satellite constellations selected from a group including of GPS, GLONASS, Galileo, and BeiDou.

9. The RTK expansion system of claim 1, wherein the communication interface is configured to transmit the real-time corrections using a wireless communication protocol selected from a group including cellular networks, Wi-Fi, radio frequency (RF) modems, or a dedicated short-range communication (DSRC) network.

10. A method of expanding coverage of a network of real-time kinematic (RTK) base stations, comprising:
expanding coverage of a network of RTK base stations by:
providing one or more RTK base stations, each of the one or more RTK base stations configured to provide real-time positioning corrections to a vehicle;
determining coverage of a current network of RTK base stations;
selecting one or more existing road infrastructure elements located outside the coverage of the current network of RTK base stations; and
adding the one or more RTK base stations to the network of RTK base stations by installing the one or more RTK base stations on one or more existing road infrastructure elements.

11. The method of claim 10, wherein expanding the coverage further comprises:
determining ranges of the one or more RTK base stations; and
selecting the one or more existing road infrastructure elements at locations such that the ranges of the one or more RTK base stations increase the coverage of the current network of RTK base stations.

12. The method of claim 10, wherein expanding the coverage further comprises:
expanding the coverage to a continuous coverage in a geographical area by the current network of RTK base stations and the one or more RTK base stations.

13. The method of claim 10, wherein adding the one or more RTK base stations further comprises:
powering the one or more RTK base station using a power supply derived from a power supply to the one or more existing road infrastructure elements.

14. The method of claim 10, wherein adding the one or more RTK base stations further comprises:
powering the one or more RTK base station using a power supply separate from a power supply to the one or more existing road infrastructure elements.

15. The method of claim 10, wherein adding the one or more RTK base stations further comprises:
powering the one or more RTK base station using a renewable power supply.

16. The method of claim 10, further comprising:
expanding the coverage using vehicle-to-vehicle (V2V) communication from the vehicles in the coverage.

17. The method of claim 10, wherein the step of providing one or more RTK base stations further comprises providing a multi-frequency GNSS antenna configured to receive signals from at least two satellite constellations selected from the group consisting of GPS, GLONASS, Galileo, and BeiDou.

18. The method of claim 10, wherein the step of transmitting real-time positioning corrections further comprises transmitting the real-time positioning corrections using a wireless communication protocol selected from the group consisting of cellular networks, Wi-Fi, radio frequency (RF) modems, or a dedicated short-range communication (DSRC) network.

19. An autonomy computing system of an autonomous vehicle comprising at least one processor in communication with at least one memory device, the at least one processor further programmed to:
communicate with an expanded network of RTK base stations, wherein the expanded network of RTK base stations includes:
one or more RTK base stations, each of the one or more RTK base stations configured to provide real-time positioning corrections to a vehicle, the RTK base station comprising:
a Global Navigation Satellite System (GNSS) antenna configured to receive GNSS signals from one or more satellite constellations;
a GNSS receiver coupled to the GNSS antenna, configured to decode the GNSS signals received from the GNSS antenna and generate real-time corrections that compensate for errors, wherein the corrections compensate for errors in satellite signal reception;
a memory configured to store the decoded the GNSS signals;
a processor configured to process decoded the GNSS signals; and
a communication interface configured to transmit real-time corrections to a moving navigation system, thereby enabling the moving navigation system to achieve high-precision positioning,
wherein the one or more RTK base stations are installed on one or more existing road infrastructure elements, locations of the one or more existing road infrastructure elements selected to be outside a coverage of a current network of RTK base stations.

20. The autonomy computing system of claim 19, wherein the autonomy computing system is configured to communicate with at least one vehicle via a vehicle-to-vehicle (V2V) communication to expand a coverage of the expanded network.
